(19) United States
(12) Patent Application Publication
(10) Pub. No.: US 2019/0031493 A1
(43) Pub. Date: Jan. 31, 2019

(54) FLUID DISPENSER

(71) Applicant: I Chuan HUANG, CHANGHUA CITY (TW)

(72) Inventor: I Chuan HUANG, CHANGHUA CITY (TW)

(21) Appl. No.: 15/660,332

(22) Filed: Jul. 26, 2017

(51) Int. Cl. B67D 7/02

(52) U.S. Cl. CPC B67D 7/0294; B67D 7/04

(57) ABSTRACT

The fluid dispenser includes a body, a door and a stop structure. The body has a nozzle. The stop structure is disposed at the nozzle. When the fluid is introduced into a container and thereby opens an exit disposed at the nozzle, the stop structure blocks an opening of the container from inside so as to confine the nozzle to the opening of the container. It is only when the fluid stops moving out of the exit and thus the door closes the exit that the stop structure no longer blocks the opening of the container, thereby allowing a user to remove the body from the container and thus prevent the fluid from splashing while being dispensed.

### BACKGROUND OF THE INVENTION

### 1. Technical Field

The present invention relates to fluid dispensers and, more particularly, to a fluid dispenser which can be coupled to a container to introduce a fluid into the container.

### 2. Description of Related Art

Referring to FIG. 8, a conventional fluid dispenser essentially comprises a body 91 and a door 96. The body 91 has: a hollow core which defines a reservoir 92; an entrance 93 and an exit 94 which are each in communication with the reservoir 92; and a nozzle 95. The door 96 is disposed at the nozzle 95. When the conventional fluid dispenser is operating, the nozzle 95 mounted on an opening 971 of a container 97 is automatically pushed open, leaving the exit 94 open, and in consequence a fluid which has been introduced into the body 91 through the entrance 93 passes through the reservoir 92 so as to be discharged from the exit 94.

When the fluid is discharged from the exit 94 and admitted into the container 97, the amount of the admitted fluid cannot be observed from the outside. To check whether the amount of the admitted fluid is enough, it is necessary to stop any more fluid from entering the container 97, then remove the body 91 from the container 97, and finally observe the amount of the admitted fluid with the naked eye through the opening 971. However, if by negligence a worker fails to stop the fluid from entering the container 97 before removing the body 91 from the container 97, the fluid running out of the exit 94 will splash. Accidents may happen, if the splashing fluid is inflammable (such as a fuel oil) or corrosive (a strong acid or a strong alkali).

### BRIEF SUMMARY OF THE INVENTION

In view of the aforesaid drawbacks of the prior art, it is an objective of the present invention to provide a fluid dispenser which comprises a body, a door and a stop structure. The body has a nozzle. The stop structure is disposed at the nozzle. When a fluid is discharged from the exit to therefore push the door open, the stop structure presses against an inner edge of an opening of a container, so as to prevent the body from separating from the container whenever the fluid is running. Hence, it is only when the fluid stops running that the body can be removed from the container. Therefore, the fluid dispenser of the present invention prevents the fluid being dispensed from splashing, which might otherwise occur if a user removes the body from the container inadvertently. Accordingly, the fluid dispenser of the present invention is safe to use.

The present invention provides a fluid dispenser mountable on an opening of a container to introduce a fluid into the container for storage. To this end, the fluid dispenser of the present invention comprises a body, a door, and a stop structure.

The body has a mounting portion whereby the body is mounted on the opening of the container, a nozzle extending into the container through the opening, a hollow core defining a reservoir, an entrance for admitting the fluid, and an exit disposed at the nozzle to discharge the fluid, wherein the entrance and the exit are each in communication with the reservoir, and a gas recycling passage not in communication with the reservoir is disposed at the nozzle.

The door is swingably disposed at the nozzle and positioned proximate to the exit to normally close the exit when the fluid is not passing through the exit.

The stop structure is disposed at the nozzle to connect with the door and moved by the door as soon as the fluid is introduced into the container to therefore open the exit, so as to press against an inner edge of the opening from inside the container, thereby confining the nozzle to the opening of the container.

The door and the stop structure are connected by a linkage mechanism whereby the stop structure is moved by the door

The linkage mechanism has a pivoting element. The pivoting element is swingably coupled to the door by a coupling element, with an oblong hole disposed on each of two opposing sides of the pivoting element in a manner that the two oblong holes are symmetrically arranged and each have an end positioned proximate to the coupling element. The two oblong holes part increasingly away from the coupling element in a lengthwise direction. The stop structure has two stop posts extending movably, penetratingly into the nozzle from two sides of the exit, respectively. In the nozzle, ends of the two stop posts are connected to the two oblong holes each by an axle, respectively. When the door closes the exit, the axles in the oblong holes are located nearest to the coupling element to allow the two stop posts to retract into the nozzle. When the door opens the exit, the axles in the oblong holes move along with the pivoting element and thus are located farthest from the coupling element, thereby allowing the two stop posts to protrude from the nozzle.

The door has a lug penetrable by the coupling element and thereby is swingably coupled to the pivoting element.

Two through holes are disposed at the nozzle and positioned at penetratingly extending points of the two stop posts, respectively, such that the stop posts retract into or protrude from the nozzle through the through holes, respectively.

The fluid dispenser further comprises a spherical valve disposed in the reservoir of the body and between the entrance and the exit, connected to a handle protruding from the body, and thereby driven by the handle, so as to switch the entrance and the exit between being in communication and thus open and being not in communication and thus closed.

### BRIEF DESCRIPTION OF THE SEVERAL VIEWS OF THE DRAWINGS

FIG. 1 is a schematic view of a fluid dispenser of the present invention;

FIG. 2 is an exploded view of the fluid dispenser of the present invention;

FIG. 3 is a cross-sectional view of the fluid dispenser connected to a container according to the present invention;

FIG. 4 is a schematic view of operation of the fluid dispenser of the present invention, with an exit closed by a door;

FIG. 5 is a schematic view of operation of the fluid dispenser of the present invention, showing the state of a linkage mechanism and stop posts when the door closes the exit;

FIG. 6 is a schematic view of operation of the fluid dispenser of the present invention, showing the state when the door opens the exit;

FIG. 7 is a schematic view of operation of the fluid dispenser of the present invention, showing the state of the linkage mechanism and the stop posts when the door opens the exit; and

FIG. 8 (PRIOR ART) is a cross-sectional view of a conventional fluid dispenser mounted on an opening of a container.

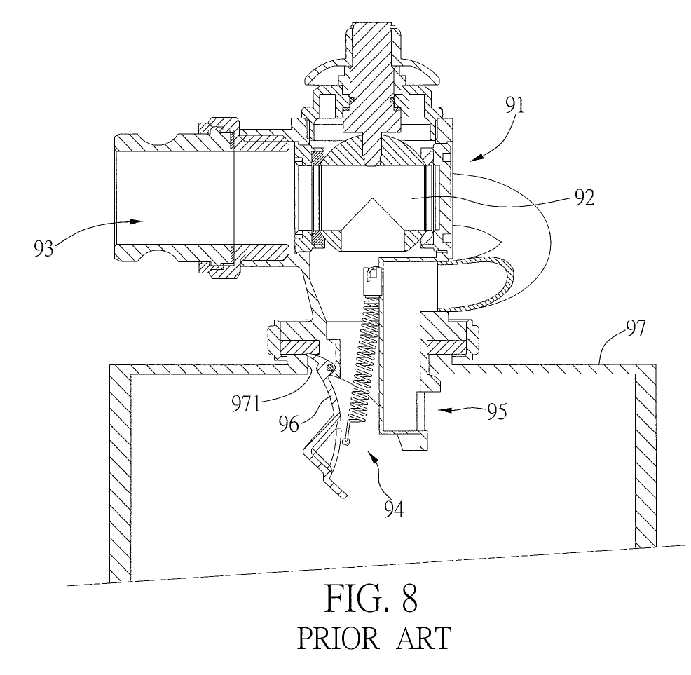

### DETAILED DESCRIPTION OF THE INVENTION

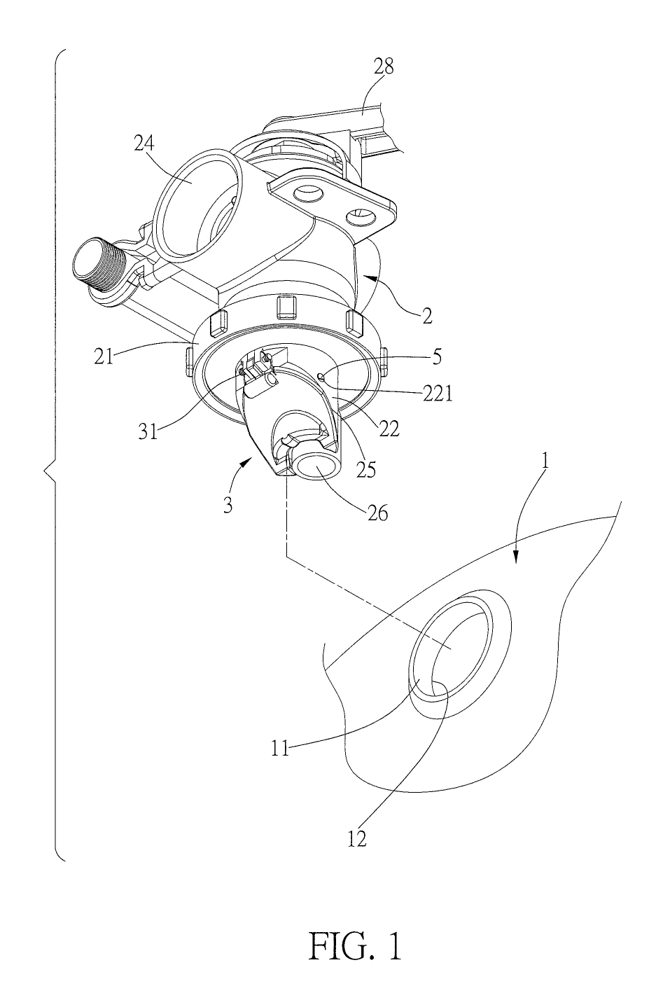

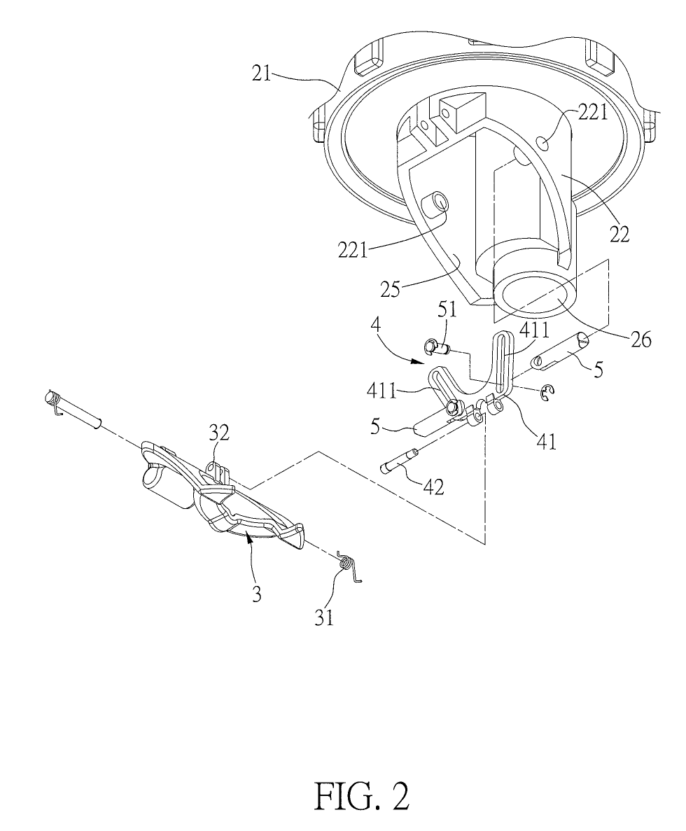

FIG. 1 and FIG. 2 depict a preferred embodiment illustrative rather than restrictive of the present invention.

The present invention provides a fluid dispenser mountable on an opening 11 of a container 1 to introduce a fluid into the container 1 for storage. In the embodiment below, the fluid is exemplified by a fuel oil, whereas the container 1 is an oil barrel which contains the fuel oil. In a variant embodiment, the fluid is a corrosive strong acid or strong alkali, concrete or any other fluid which needs to be contained and stored.

Referring to FIG. 1 and FIG. 2, the fluid dispenser essentially comprises a body 2, a door 3 and a stop structure.

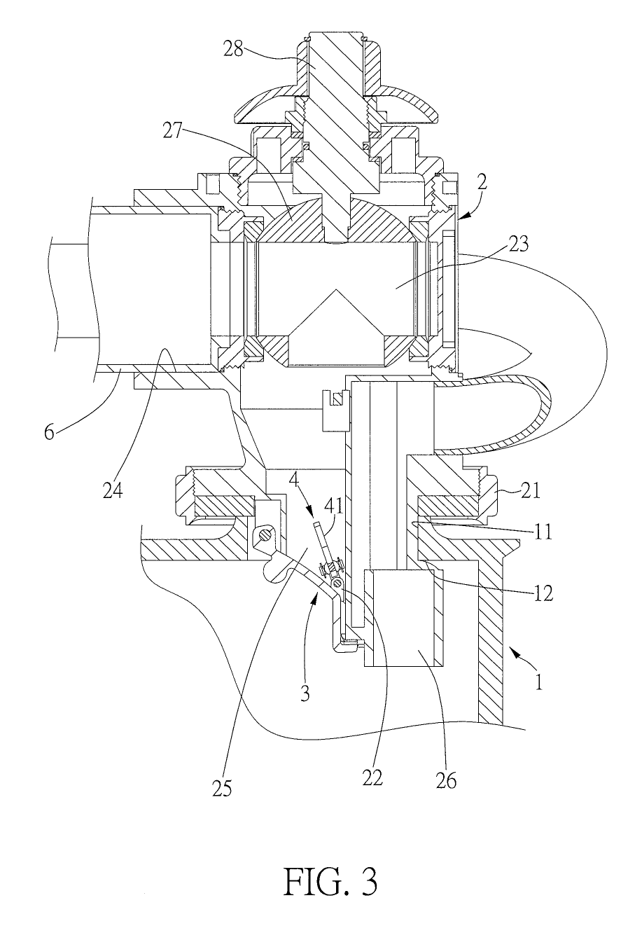

Referring to FIG. 3, the body 2 has a mounting portion 21 whereby the body 2 is mounted on the opening 11 of the container 1. The body 2 further has a nozzle 22 which extends into the container 1 through the opening 11. The body 2 not only has a hollow core which defines a reservoir 23, but also has an entrance 24 and an exit 25. The entrance 24 admits the fluid to be introduced into the body 2. The exit 25 is disposed at the nozzle 22 to discharge the fluid from the body 2. The entrance 24 and the exit 25 are each in communication with the reservoir 23. The fluid enters the entrance 24, passes through the reservoir 23, and reaches the exit 25. The nozzle 22 further has a gas recycling passage 26. The gas recycling passage 26 is not in communication with the reservoir 23. Oil vapor generated from the fuel oil being introduced into the container 1 is released by the gas recycling passage 26 to prevent accumulation of the oil vapor in the container 1. Furthermore, if the fluid is concrete, dust generated can be removed by the gas recycling passage 26.

Referring to FIGS. 1-3, the door 3 is swingably disposed at the nozzle 22 and positioned proximate to the exit 25 to normally close the exit 25 when the fluid is not passing through the exit 25. In a preferred embodiment, a torsion spring 31 is mounted in place at the point where the door 3 is swingably disposed at the nozzle 22 so that the torsion spring 31 provides a restoring force when the door 3 opens, thereby allowing the door 3 to normally close the exit 25.

The stop structure is disposed at the nozzle 22 to connect with the door 3 and moved by the door 3 as soon as the fluid is introduced into the container 1 to therefore open the exit 25, so as to press against an inner edge 12 of the opening 11 from inside the container 1, so as to confine the nozzle 22 to the opening 11 of the container 1. Preferably, the door 3 and the stop structure are connected by a linkage mechanism 4 whereby the stop structure is moved by the door 3.

In a preferred embodiment of the present invention, the linkage mechanism 4 has a pivoting element 41. The pivoting element 41 is swingably coupled to the door 3 by a coupling element 42. An oblong hole 411 is disposed on each of two opposing sides of the pivoting element 41 in a manner that the two oblong holes 411 are symmetrically arranged and each have an end positioned proximate to the coupling element 42. The two oblong holes 411 part increasingly away from the coupling element 42 in a lengthwise direction; hence, the ends of the two oblong holes 411 are separated by the shortest distance when they are near the coupling element 42, whereas the ends of the two oblong holes 411 are separated by the longest distance when they are far from the coupling element 42. In a preferred embodiment, the door 3 has a lug 32, and the lug 32 is penetrable by the coupling element 42, and in consequence the pivoting element 41 is swingably coupled to the door 3.

The stop structure has two stop posts 5. The two stop posts 5 movably, penetratingly extend into the nozzle 22 from the two sides of the exit 25 of the body 2, respectively. In the nozzle 22, ends of the two stop posts 5 are connected to the two oblong holes 411 each by an axle 51, respectively. When the door 3 closes the exit 25, the axles 51 in the oblong holes 411 are located nearest to the coupling element 42 to allow the two stop posts 5 to retract into the nozzle 22. When the door 3 opens the exit 25, the axles 51 in the oblong holes 411 move along with the pivoting element 41 and thus are located farthest from the coupling element 42, thereby allowing the two stop posts 5 to protrude from the nozzle 22. In a preferred embodiment, two through holes 221 are disposed at the nozzle 22 and positioned at penetratingly extending points of the two stop posts 5, respectively. The stop posts 5 retract into or protrude from the nozzle 22 through the through holes 221, respectively.

In a preferred embodiment, the body 2 comprises a spherical valve 27. The spherical valve 27 is disposed in the reservoir 23 of the body 2 and between the entrance 24 and the exit 25. The spherical valve 27 is connected to a handle 28 protruding from the body 2 and thereby driven by the handle 28. A user moves the handle 28 to therefore drive the spherical valve 27 to rotate, so as to switch the entrance 24 and the exit 25 between being in communication and thus open and being not in communication and thus closed.

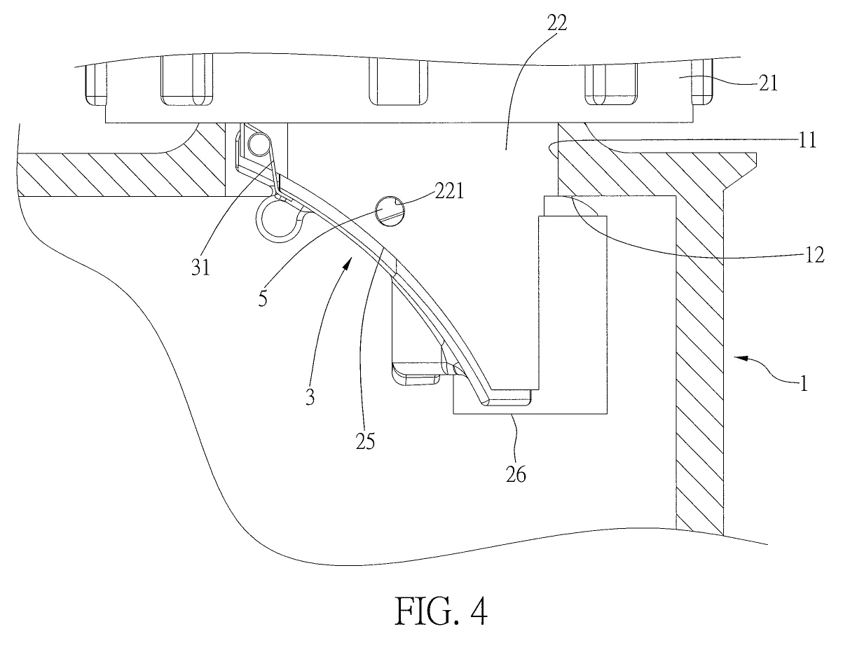

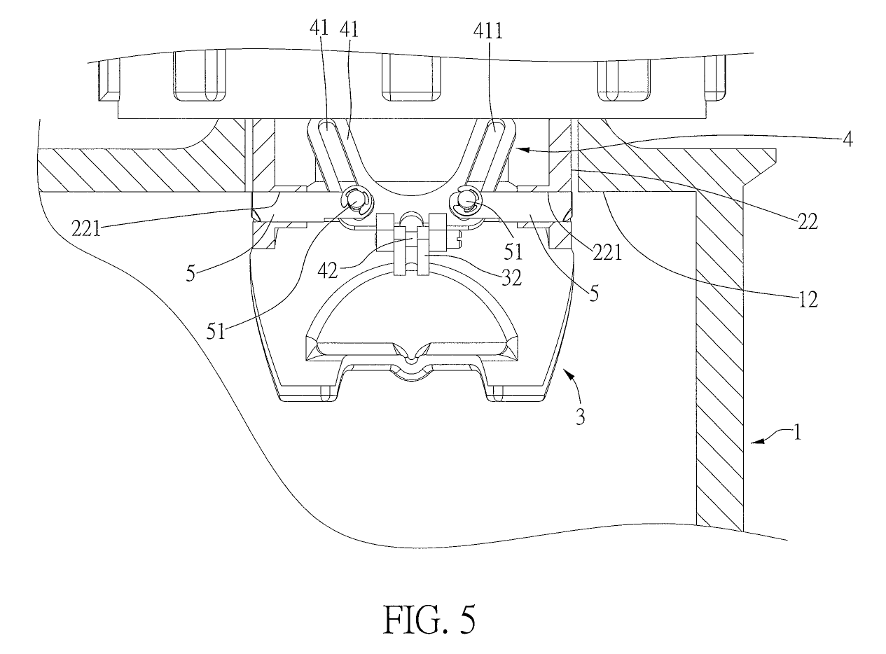

In a preferred embodiment of the present invention, technical features of the fluid dispenser are further described below. A pipeline 6 which the fluid passes through is connected to the entrance 24. The door 3 remains in a state that allows the door 3 to close the exit 25, as shown in FIGS. 4, 5. The two stop posts 5 retract into the nozzle 22, and thus the nozzle 22 extends into the container 1 through the opening 11 of the container 1 so that the nozzle 22 becomes coupled to the container 1; meanwhile, the fluid is introduced to the reservoir 23 by the pipeline 6 through the entrance 24. The user moves the handle 28 so that the entrance 24 and the exit 25 are in communication and thus open to therefore allow the fluid to pass through the exit 25, and in consequence the door 3 is pushed open by the passing fluid, thereby introducing the fluid into the container 1.

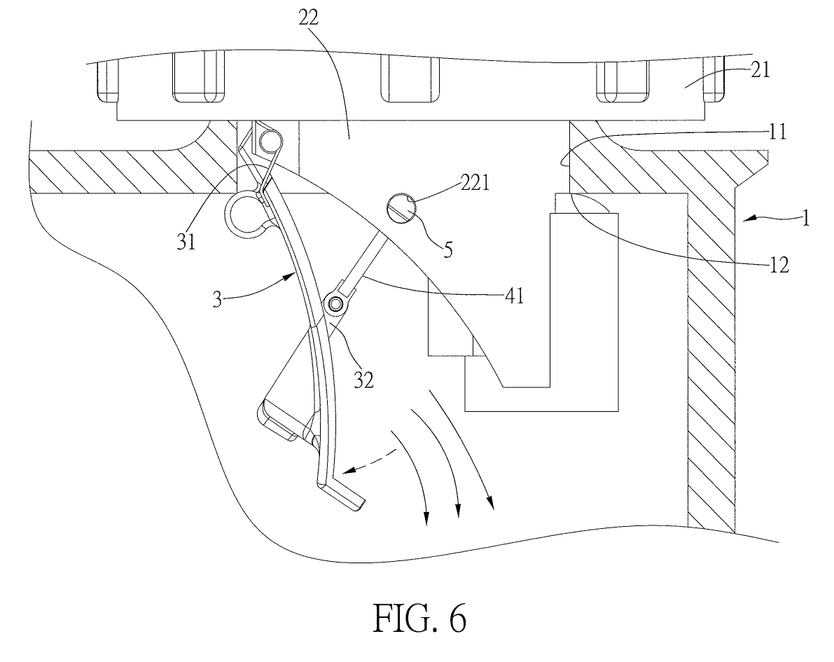

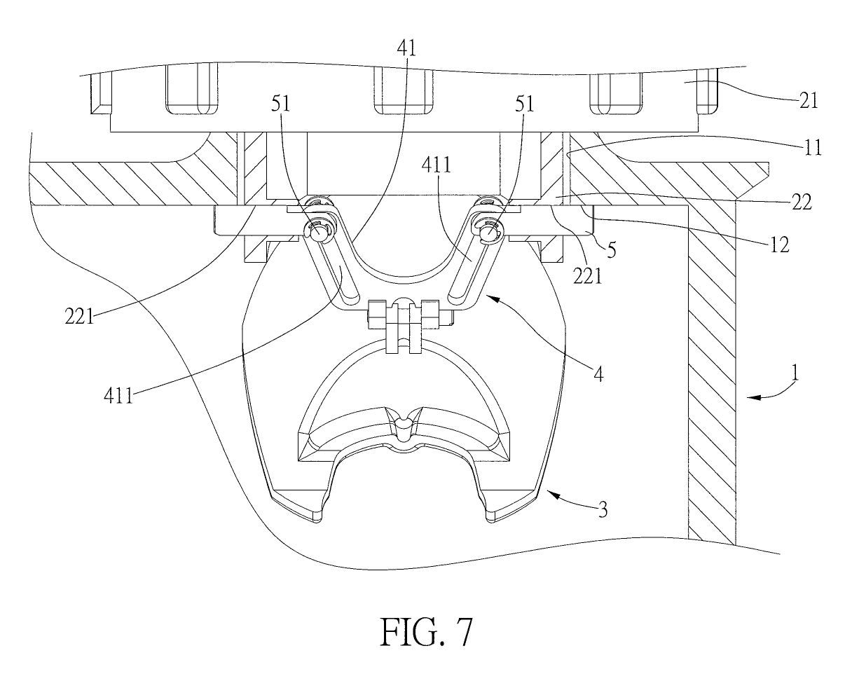

Referring to FIGS. 6, 7, when the door 3 opens the exit 25, the coupling element 42 is coupled to the pivoting element 41 of the door 3 and moves along with the door 3; meanwhile, the two stop posts 5 protrude from the nozzle 22 and thus press against the inner edge 12 of the opening 11 from inside the container 1. Hence, if the fluid is running, the two stop posts 5 will prevent the body 2 from separating from the container 1. To remove the body 2 from the container 1, the user must stop the fluid from running, so as to allow the door 3 to return to the position of closing the exit 25 and allow the two stop posts 5 to retract into the nozzle 22, and then the user takes the nozzle 22 away from the opening 11, thereby removing the body 2 from the container 1.

To overcome the drawbacks of the prior art, the present invention provides a fluid dispenser briefly described below. The stop structure is disposed at the nozzle 22 of the body 2. When the fluid is discharged from the exit 25, the passing fluid pushes the door 3 open, and thus the opening door 3 drives the stop structure to move. As a result, due to the pivotal swing of the pivoting element 41, the two stop posts 5 of the stop structure protrude from the nozzle 22 through the through holes 221 and thereby press against the inner edge 12 of the opening 11 of the container 1, so as to prevent the body 2 from separating from the container 1 whenever the fluid is running. Therefore, the fluid dispenser of the present invention prevents the fluid being dispensed from splashing, which might otherwise occur if a user removes the body 2 from the container 1 inadvertently. Accordingly, unlike conventional fluid dispensers, the fluid dispenser of the present invention is safe to use.

What is claimed is:

1. A fluid dispenser mountable on an opening of a container to introduce a fluid into the container for storage, comprising:
a body having a mounting portion whereby the body is mounted on the opening of the container, a nozzle extending into the container through the opening, a hollow core defining a reservoir, an entrance for admitting the fluid, and an exit disposed at the nozzle to discharge the fluid, wherein the entrance and the exit are each in communication with the reservoir, and a gas recycling passage not in communication with the reservoir is disposed at the nozzle;
a door swingably disposed at the nozzle and positioned proximate to the exit to normally close the exit when the fluid is not passing through the exit; and
a stop structure disposed at the nozzle to connect with the door and moved by the door as soon as the fluid is introduced into the container to therefore open the exit, so as to press against an inner edge of the opening from inside the container, thereby confining the nozzle to the opening of the container.

2. The fluid dispenser of claim 1, wherein the door and the stop structure are connected by a linkage mechanism whereby the stop structure is moved by the door.

3. The fluid dispenser of claim 2, wherein the linkage mechanism has a pivoting element, the pivoting element being swingably coupled to the door by a coupling element, with an oblong hole disposed on each of two opposing sides of the pivoting element in a manner that the two oblong holes are symmetrically arranged and each have an end positioned proximate to the coupling element, wherein the two oblong holes part increasingly away from the coupling element in a lengthwise direction, wherein the stop structure has two stop posts extending movably, penetratingly into the nozzle from two sides of the exit, respectively, wherein, in the nozzle, ends of the two stop posts are connected to the two oblong holes each by an axle, respectively, wherein, when the door closes the exit, the axles in the oblong holes are located nearest to the coupling element to allow the two stop posts to retract into the nozzle, wherein, when the door opens the exit, the axles in the oblong holes move along with the pivoting element and thus are located farthest from the coupling element, thereby allowing the two stop posts to protrude from the nozzle.

4. The fluid dispenser of claim 3, wherein the door has a lug penetrable by the coupling element and thereby is swingably coupled to the pivoting element.

5. The fluid dispenser of claim 3, wherein two through holes are disposed at the nozzle and positioned at penetratingly extending points of the two stop posts, respectively, such that the stop posts retract into or protrude from the nozzle through the through holes, respectively.

6. The fluid dispenser of claim 1, further comprising a spherical valve disposed in the reservoir of the body and between the entrance and the exit, connected to a handle protruding from the body, and thereby driven by the handle, so as to switch the entrance and the exit between being in communication and thus open and being not in communication and thus closed.
